(19) United States
(12) Patent Application Publication
(10) Pub. No.: US 2024/0006111 A1
(43) Pub. Date: Jan. 4, 2024

(54) TRANSFORMER WITH AIR-FLOW RE-DIRECTOR

(71) Applicant: HITACHI ENERGY SWITZERLAND AG, Baden (CH)

(72) Inventors: QingJun SUN, Shanghai (CN); Ye XU, Shanghai (CN)

(21) Appl. No.: 18/038,752

(22) PCT Filed: Aug. 13, 2021
(86) PCT No.: PCT/EP2021/072654

§ 371 Date: May 25, 2023

(30) Foreign Application Priority Data
Nov. 26, 2020 (CN) 202022781487.5

(51) Int. Cl. H01F 27/20; H01F 3/14; H01F 27/28; H01F 41/02

(52) U.S. Cl. CPC H01F 27/20; H01F 3/14; H01F 27/28; H01F 41/02

(57) ABSTRACT

A transformer including a core, a plurality of winding coils arranged in proximity of the core to inductively couple to the core, a plurality of air-gaps to allow air flow in the proximity of at least one of the core and winding coils, and an air-flow re-director including a plurality of independently adjustable surfaces angled to re-direct a flow of a portion of a cooling air received into the re-director into at least one pre-determined air-gap.

### CROSS REFERENCE TO RELATED APPLICATIONS

This application is a 35 U.S.C. § 371 national stage application of PCT International Application No. PCT/EP2021/072654 filed on Aug. 13, 2021, which in turn claims priority to Chinese Application No. 202022781487.5, filed on Nov. 26, 2020, the disclosures and content of which are incorporated by reference herein in their entirety.

### TECHNICAL FIELD

Aspects of the disclosure relate to transformers, and in particular to the air-cooling of transformers during operation.

### BACKGROUND

Transformers are used to convert electricity from a voltage level to electricity at either of higher or lower voltage level in an electrical circuit. Typical transformers comprise two sets of insulated wire coiled around a ferromagnetic core forming high voltage (HV) winding coil(s) and low voltage (LV) winding coil(s). When electrical power is applied to one winding that draws power from a source of voltage, it is then magnetically transferred to another winding that delivers power to a load at a transformed or changed voltage. The ratio of turns in one winding to the turns in another winding is the same as the ratio of the voltage of the source to the voltage of the load.

In dry-type transformers, typically used for power distribution networks, no dielectric liquid is used for insulating the winding coil(s). Dry transformer performance, however, can be highly limited by temperature rise due to losses and heat dissipation efficiency, and therefore air-forced cooling are employed to reduce their temperature rise.

Currently, centrifugal fans with very high air-flow rate are typically used for this air-forced cooling. A problem with the forgoing approach is that a substantial portion (e.g. 40%) of the cooling air flow can become directed away from the transformer due to diverge direction of centrifugal fans, resulting in wasted cooling air and thus inefficient cooling of the transformer.

Exemplary embodiments of the disclosure address these problems, both individually and collectively.

### SUMMARY

Exemplary embodiments of the disclosure include a transformer including a core, a plurality of winding coils arranged in proximity of the core to inductively couple to the core, a plurality of air-gaps to allow air flow in the proximity of at least one of the core and winding coils, and an air-flow re-director including a plurality of independently adjustable surfaces angled to re-direct a flow of a portion of a cooling air received into the re-director into at least one pre-determined air-gap.

### BRIEF DESCRIPTION OF THE DRAWINGS

Aspects of the present disclosure are illustrated by way of example. In the accompanying figures, like reference numbers indicate similar elements.

FIG. 1 illustrates a perspective view of a transformer environment in which various aspects of the present disclosure can be implemented.

FIG. 2 illustrates a perspective view of an exemplary implementation of an aspect of the present disclosure.

FIG. 3 illustrates cross-sectional views of the exemplary implementations shown in FIG. 1 and FIG. 2.

FIG. 4 illustrates a perspective view of an alternate exemplary implementation of an aspect of the present disclosure.

### DETAILED DESCRIPTION

Examples are described herein in the context of an air-cooled dry-type transformer. Exemplary embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

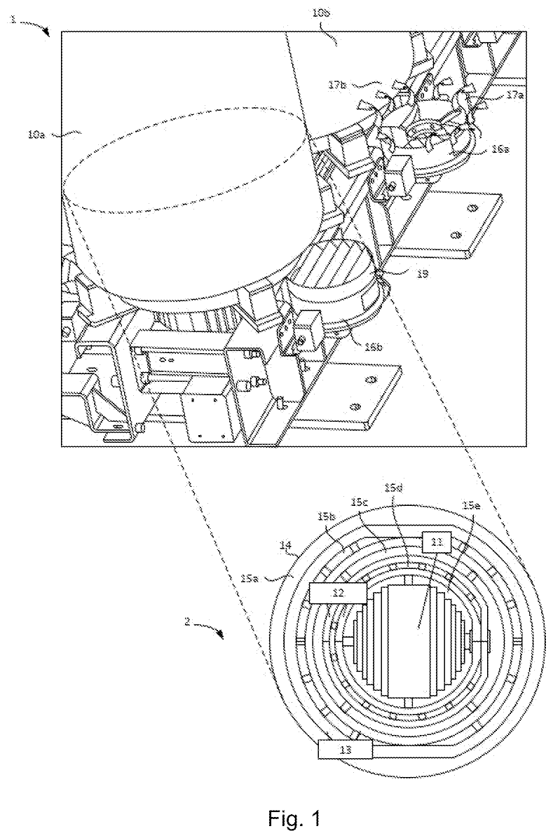

FIG. 1 illustrates a perspective view of a transformer environment 1 in which various aspects of the disclosure can be implemented. As shown in FIG. 1, exemplary transformer environment 1 includes transformers 10a and 10b that are air-forced cooled by their centrifugal fans 16a and 16b, respectively. As shown in the cross-section view 2, transformer 10a includes a core 11, and winding coils 12 and 13 arranged in proximity of the core 11 to inductively couple to the core 11. In an exemplary embodiment, at least one of the winding coil(s) 12 and 13 is configured to operate at a different voltage than the other winding coil(s). In the example shown in FIG. 1, winding coil(s) 12 are operated at a low-voltage and winding coil(s) 13 are operated at a high-voltage.

As further shown in FIG. 1, transformer 10a, such as a dry-type transformer, includes air-gaps, such as 15a-e, to allow flow of cooling air in the proximity of at least one of the core 11 and winding coils 12 and 13. The air-gaps are defined by at least one of the core 11 and winding coils 12 and 13. In the example shown in FIG. 1, air-gap 15e is defined by core 11 and an inner winding coil 12, air-gap 15d is defined by the inner and outer winding coils 12, air-gap 15c is defined by an outer winding coil 12 and an inner winding coil 13, air-gap 15b is defined by the inner and outer winding coils 13, and air-gap 15a is defined as an external surface of an outermost winding coil 13 positioned farthest from the core, such as the area between outermost coil 13 and a transformer housing 14, such as a horizontal barrier. In an exemplary embodiment, core 11 may also include one or more air-gaps (not shown) for improved air-cooling of coil 11.

As previously mentioned, currently centrifugal fans, such as 16b shown in FIG. 1, are typically used for air-forced cooling. A problem with the forgoing approach is that due to divergent air-flow directions created by centrifugal fan 16b, as shown symbolically by arrows 17a and 17b, a substantial portion (e.g. 40%) of the cooling air flow 17b can become directed away from transformer 10b, resulting in wasted cooling air 17b and inefficient cooling of transformer 10b.

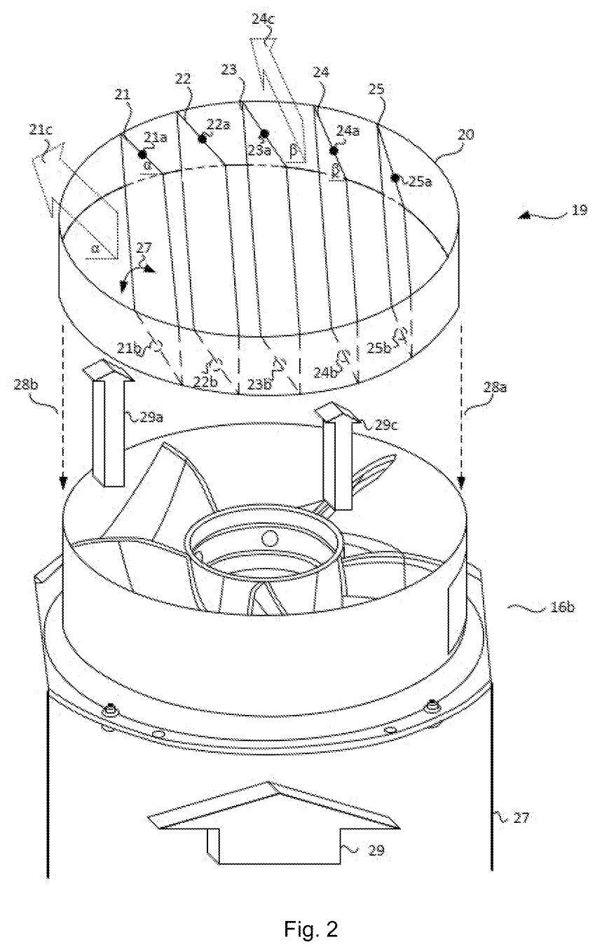

To address the above, in the exemplary embodiments of the disclosure, transformer 10a includes an air-flow re-director 19 with independently adjustable surfaces, such as 21-15 as later shown in FIG. 2, angled to re-direct a flow of a portion of a cooling air received into the re-director 19 from a centrifugal fan 16b into at least one pre-determined air-gap, such as 15a-e, as discussed below and in greater detail in conjunction with FIGS. 2-4.

FIG. 2 illustrates a perspective view of an exemplary implementation of an air-flow re-director 19 of FIG. 1. As shown in FIG. 2, the air-flow re-director 19 includes independently adjustable surfaces 21-25 that can be slanted to a desired angle, such as a or R, to re-direct a flow of a portion of a cooling air received into the re-director 19, such as air-flow portions shown symbolically by arrows 29a and 29c received from the centrifugal fan 16b. In an exemplary embodiment, the centrifugal fan 16b is connected to, or is a part of, a fan system (not shown), such an axial fan system which provides cooling air 29. For simplicity of illustration, only five independently adjustable surfaces 21-25 are shown in FIG. 2, although different number of independently adjustable surfaces are also contemplated to be within the scope of the disclosure.

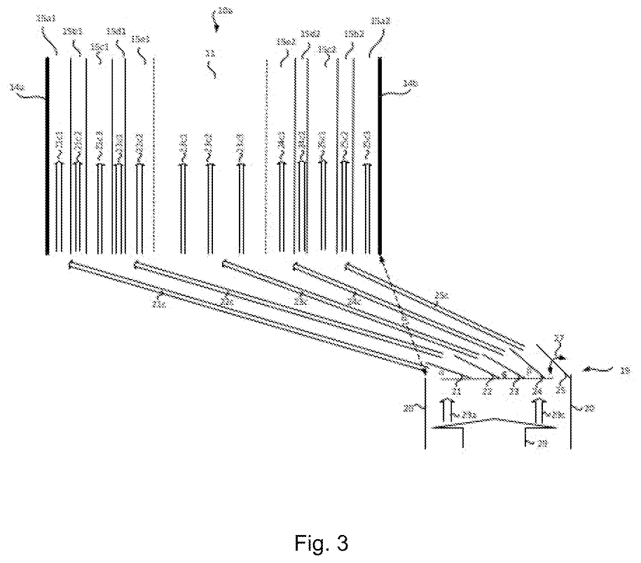

In an exemplary embodiment, at least two of the independently adjustable surfaces 21-25 are angled differently from each other to direct flows from different portions of the received cooling air to different pre-determined air-gaps 15a-e. For example, independently adjustable surface 21 is set at an angle α which redirects a received air-flow portion 29a to a new direction shown symbolically by arrow 21c. In another example, independently adjustable surface 24 is set at an angle β which redirects a received air-flow portion 29c to a new direction shown symbolically by arrow 24c. As described below and in great detail in conjunction with FIG. 3, the airflows 21c and 24c, are directed toward one or more pre-determined air-gaps 15a-e.

In an exemplary embodiment, air-flow re-director 19 includes a support structure 20, such as a frame, to which the independently adjustable surfaces 21-25 are adjustably attached, or with which they are integrally formed. In an exemplary embodiment, one or more of the independently adjustable surfaces 21-25 may be rotatably attached to the support structure 20 at rotating points 21a-25a and 21b-25b, such as via a screw or a controllable rotate shaft or other rotatably connections, or a guide railing (not shown) or other adjusting methods. The rotatable connection enables each of independently adjustable surfaces 21-25 to be moved along a wide range of angled settings, such as symbolically shown by arrow 27. In another exemplary embodiment, surfaces 21-25 are integrally formed with support structures 20 at predetermined angles, such as angles α and β for directing air toward one or more pre-determined air-gaps 15a-e.

The support structure 20 may also function as an air-guide to reduce or eliminate the outwardly divergent direction of the air flow, such as shown symbolically by arrows 17a and 17b in FIG. 1, from centrifugal fan 16b, and to guide the air-flow, such as shown symbolically by arrows 29a and 29c in FIG. 2, in the general direction of the redirecting surfaces 21-25.

The example support structure 20 in FIG. 2 is shown as generally circular in shape although various geometric configuration such as oval, rectangular and multi-angular (e.g. pentagonal, hexagonal, etc.), are also contemplated to be within the scope of the disclosure.

In an exemplary embodiment, the air-flow re-director 19 is coupled via the support structure 20, as shown symbolically by arrows 28a and 28b, to a fan system (not shown) that provides the cooling air 29. The fan system may include an air duct 27, or be connected to the air-flow re-director 19 via an air duct 27, that provides the cooling air 29. In another exemplary embodiment, the air-flow re-director 19 is integrally formed with at least a portion of the fan system, such as with the centrifugal fan 16b.

The operation of the air-flow redirector 19 will now be explained in greater detail in conjunction with FIG. 3, which further illustrates cross-sectional views of the exemplary implementations shown in FIG. 1 and FIG. 2. For illustrative purposes, each of air-gaps 15a-e in FIG. 1 are shown as sub-portions depending on the proximity of each sub-portion to the air-flow re-director 19. For example, air-gap 15a is shown as sub-portions 15a1 and 15a2, air-gap 15b is shown as sub-portions 15b1 and 15b2, air-gap 15c is shown as sub-portions 15c1 and 15c2, air-gap 15d is shown as sub-portions 15d1 and 15d2, and air-gap 15e is shown as sub-portions 15e1 and 15e2, while housing 14 is also shown as sub-portions 14a and 14b.

As shown in the exemplary setting of FIG. 3, air-flow re-director 19 receives cooling air 29 via centrifugal fan 16b, with portions of cooling air 29, such as air-flow portions 29a and 29c received by one or more independently adjustable surfaces 21-25, such as adjustable surfaces 21 and 24. Based on their independently adjusted angles (e.g. α or β), adjustable surfaces 21 and 24 then have air-flow portions 29a and 29c redirected, as symbolically shown by corresponding air flow arrows 21c and 24c respectively, to pre-determined air-gap(s) or sub-portion(s), such as sub-portions 15a1, 15b1, 15c1, and 15e2, 15d2, respectively. The air-flow portions 21c and 24c then flow inside their directed to sub-portions 15a1, 15b1, 15c1, and 15e2, 15d2, as shown by corresponding air flow sub-portions 21c1-21c3 and 24c1-24c2, respectively.

Likewise, other independently adjustable surfaces, such as 22, 23 and 25, can each be set at angles so to redirect their air flow portions to different air-gaps or sub-portions thereof. In the exemplary setting of FIG. 3, independently adjustable surface 22 is angled such that air flow portion 22c is directed to air-gap sub-portions 15d1 and 15el, which then flow inside sub-portions 15d1 and 15el, as symbolically shown by corresponding air flow arrows 22c1-22c2. Independently adjustable surface 23 is angled such that air flow portion 23c is directed to the core 11 which can then flow inside its any air-gaps (not shown), as symbolically shown by corresponding air flow arrows 23c1-23c3. Independently adjustable surface 25 is angled such that air flow portion 25c is directed to air-gap sub-portions 15c2, 15b2, 15a2, which then flow inside sub-portions 15c2, 15b2, 15a2, as symbolically shown by corresponding air flow arrows 25c1-25c3.

In an exemplary embodiment, more than one independently adjustable surface can be directed to any air-gap(s) or sub-portion(s) thereof based on the cooling needs of each air-gap or sub-portion(s) thereof. For example more than one independently adjustable surface can be angled so to redirect air-flow to air-gap(s) or sub-portion(s) thereof corresponding to winding coils 12 or 13, for cooling of high-voltage or low-voltage coil windings, respectively.

In an exemplary embodiment, air-flow portions are directed to their pre-determined air-gap(s) or sub-portion(s) at substantially the same angle as their corresponding redirecting adjustable surface, such as at angle α of adjustable surface 21, or at an angle ranging between adjustable surfaces adjacent to an air flow portion, such as air-flow portion 24c being redirected at an angle (e.g. an average angle) between angles β and σ of adjacent adjustable surfaces 23 and 24.

In an exemplary embodiment, air-flow re-director 19 is of a dielectric composition (e.g. plastic) and positioned at a predetermined dielectric distance dl (e.g. 4-20 cm) from the housing 14, as shown in FIG. 3. The distance dl can be selected based on the voltage class of a transformer, such that the higher the class transformer class the larger the distance dl, for example, about 6 cm for a 10 kV transformer, and about 15 cm for a 35 kV transformer.

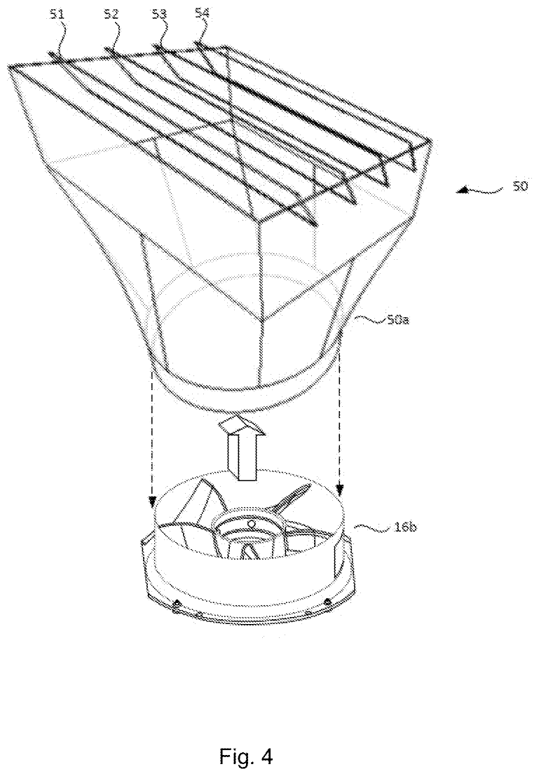

FIG. 4 illustrates a perspective view of an alternate exemplary implementation, of an air-flow re-director 50, which includes an air-duct 50a to receive the cooling air from centrifugal fan 16b and to direct the cooling air to its independently adjustable surfaces, such as 51-54. In an exemplary embodiment, the air-duct 50a can be connect to or integrally formed with a supporting structure of the air-flow re-director 50, and/or the fan system. Air-duct 50a enables the centrifugal fan 16b and/or the fan system to be placed at a greater distance from the transformer 10a, such as at a much lower plane that that of transformer 10a.

The above-described exemplary embodiments enables a more efficient providing and distribution of cooling-air to the air-gaps in a transformer which helps with better reduction in temperature rise of the transformer resulting in improvement to the reliability of the transformer, heat transfer efficiency, and material cost savings. amongst other benefits.

The previous description is provided to enable any person skilled in the art to practice the various aspects described herein. Various modifications to these aspects will be readily apparent to those skilled in the art, and the generic principles defined herein may be applied to other aspects.

The foregoing description has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A transformer comprising:
a core;
a plurality of winding coils arranged in proximity of the core to inductively couple to the core;
a plurality of air-gaps to allow air flow in the proximity of at least one of the core and winding coils; and
an air-flow re-director including a plurality of independently adjustable surfaces angled to re-direct a flow of a portion of a cooling air received into the re-director into at least one pre-determined air-gap.

2. The transformer of claim 1, wherein at least two of the independently adjustable surfaces are angled differently from each other to direct flows from different portions of the received cooling air to different pre-determined air-gaps.

3. The transformer of claim 1, the air-flow re-director further comprising:
a support structure wherein the independently adjustable surfaces are adjustably attached to the support structure.

4. The transformer of claim 1, wherein the air-flow re-director is coupled to a fan system that provides the cooling air.

5. The transformer of claim 1, wherein the air-flow re-director is integrally formed with at least a portion of a fan system that provides the cooling air.

6. The transformer of claim 4, wherein the fan system comprises an axial fan system.

7. The transformer of claim 1, wherein at least one of the winding coils is configured to operate at a different voltage than the other winding coils.

8. The transformer of claim 1, wherein at least one air-gap comprises an external surface of a coil positioned farthest from the core.

9. The transformer of claim 1, wherein the air-flow re-director is positioned at a predetermined dielectric distance from the core and winding coils.

10. The transformer of claim 1, wherein the air-flow re-director is of a substantially dielectric composition.

11. The transformer of claim 1, wherein the air-gaps are defined by at least one of the core and winding coils.

12. The transformer of claim 1, wherein the transformer comprises a dry-type transformer.

13. The transformer of claim 3, the air-flow re-director further comprising:
an air-duct to receive the cooling air and to direct the cooling air to the independently adjustable surfaces.

14. An air-flow re-director comprising a plurality of independently adjustable surfaces angled to re-direct a flow of a portion of a cooling air received into the re-director into at least one pre-determined air-gap of a plurality of air-gaps proximate to at least one of a core and a winding coil of a transformer.

15. The air-flow re-director of claim 14, wherein at least two of the independently adjustable surfaces are angled differently from each other to direct flows from different portions of the received cooling air to different pre-determined air-gaps.

16. The air-flow re-director of claim 14, the air-flow re-director further comprising:
a support structure wherein the independently adjustable surfaces are adjustably attached to the support structure.

17. The air-flow re-director of claim 14, wherein the air-flow re-director is coupled to a fan system that provides the cooling air.

18. The air-flow re-director of claim 17, wherein the fan system comprises an axial fan system.

19. The air-flow re-director of claim 14, wherein the air-flow re-director is integrally formed with at least a portion of a fan system that provides the cooling air.

20. A method comprising:
disposing an air-flow re-director proximate to a transformer comprising a core and a plurality of winding coils arranged in proximity of the core to inductively couple to the core; and
angling a plurality of independently adjustable surfaces of the air-flow re-director to re-direct a flow of a portion of a cooling air received into the re-director into at least one pre-determined air-gap of a plurality of air-gaps to allow air flow in the proximity of at least one of the core and winding coils.
